(19) United States
(12) Patent Application Publication
(10) Pub. No.: US 2016/0119181 A1
(43) Pub. Date: Apr. 28, 2016

(54) NETWORK STATE MONITORING SYSTEM

(71) Applicant: Oki Electric Industry Co., Ltd., Tokyo (JP)

(72) Inventor: Tomoyasu SUZUKI, Tokyo (JP)

(73) Assignee: OKI ELECTRIC INDUSTRY CO., LTD., Tokyo (JP)

(21) Appl. No.: 14/369,725

(22) PCT Filed: Oct. 9, 2013
(86) PCT No.: PCT/JP2013/077427

§ 371 Date: Jun. 30, 2014

(30) Foreign Application Priority Data
Jan. 16, 2013 (JP) 2013-005657

(51) Int. Cl. H04L 12/24; H04L 12/26

(52) U.S. Cl. CPC H04L 41/0695; H04L 41/0213; H04L 43/0817

(57) ABSTRACT

In a device monitoring system for a communication network, an SNMP monitor acquires state information of devices to be monitored from a group under monitoring, and monitors the states of the devices to be monitored. A command monitor uses a monitor command to acquire the state information of the devices to be monitored. A monitor manager checks monitoring conditions of the devices to be monitored by the SNMP monitor, and sets, if there is a device to be monitored from which state information has failed to obtain, the device as a new target for monitoring and causes the command monitor to transmit a monitor command. The monitoring result is updated by the state information acquired by the command, thereby improving the reliability of failure monitoring.

### TECHNICAL FIELD

The present invention relates to a monitoring system, for example, a monitoring system which monitors the states of devices located on a network.

### BACKGROUND ART

Various devices are located on a telecommunications network such as IP (Internet Protocol) network. Heretofore, in order to monitor the states of such devices, a failure monitoring scheme described as follows has been applied, for example. That is, such a failure monitoring scheme uses, for example, a monitoring device based on an SNMP (Simple Network Management Protocol), the monitoring device being adapted to reference information stored in an MIB (Management Information Base) of a device to be monitored, and the monitoring device being adapted to analyze a response result to a specific command between the monitoring device and the device to be monitored, thus monitoring the device state of the device to be monitored is monitored to display the device state as a monitoring result on a display unit of a maintenance terminal or the like.

Japanese patent laid-open publication No. 2000-69119 discloses a reliable communication method in a network management system. This technique ensures the reliability of a communication route in the network management system managed according to a network management protocol. In the disclosed technique, a monitoring device checks the reliability of a plurality of communication routes by SNMP.

Japanese patent laid-open publication No. 154950/1999 discloses a network management device which transmits and receives an SNMP Trap and an SNMP GET message between network management equipment and a network device under management in order to manage equipment state detailed information of the network device under management, whereby a monitoring device recognizes a change in state of the device under management.

However, a failure may occur, for example in communication according to SNMP or in an SNMP agent on a device to be monitored. If a monitoring device uses SNMP in order to grasp the state of a device to be monitored as before, the monitoring device would become hard to recognize the state of the device to be monitored when a failure occurs. Because both of the conventional solutions taught by the references is directed to techniques using SNMP, a monitoring device of a monitoring system to which such solutions are applied has a problem that the state of a device to be monitored cannot be understood when a failure occurs in connection with SNMP.

### SUMMARY OF THE INVENTION

It is an object of the present invention to provide a monitoring system which can acquire state information of a device to be monitored even when a failure occurs in connection with SNMP.

A monitoring system according to the present invention comprises: a first monitor which acquires state information from each of a plurality of devices to be monitored based on a first monitoring scheme, and monitors the states of those devices to be monitored; a second monitor which is responsive to an instruction based on a second monitoring scheme to acquire state information from any device to be monitored, and monitors the state of the device to be monitored; and a monitor manager which manages monitoring results for those devices to be monitored, wherein the monitor manager acquires the state information by the first monitor to manage the state information, and provides, when the state information has failed from one of the plurality of devices to be monitored, the second monitor with the instruction to set the one device as a new target for monitoring for acquiring the state information to use the state information acquired by the second monitor in response to the instruction to manage the monitoring result.

A monitoring apparatus according to the present invention comprises: a first monitor which acquires state information from each of a plurality of devices to be monitored based on a first monitoring scheme, and monitors the states of those devices to be monitored; a second monitor which is responsive to an instruction based on a second monitoring scheme to acquire state information from any device to be monitored, and monitors the state of the device to be monitored; and a monitor manager which manages monitoring results for those devices to be monitored, wherein the monitor manager acquires the state information by the first monitor to manage the state information, and, when the state information has failed to acquire from one of the plurality of devices to be monitored, the manager provides the second monitor with the instruction to set the one device as a new target for monitoring for acquiring the state information, and uses the state information acquired by the second monitor in response to the instruction to manage the monitoring result.

A monitoring method according to the present invention, in a monitoring method for monitoring based on state information from each of a plurality of device to be monitored, uses a monitoring apparatus comprising: a first monitor which acquires state information from each of the plurality of devices to be monitored based on a first monitoring scheme, and monitors the states of the plurality of devices to be monitored; a second monitor which is responsive to an instruction based on a second monitoring scheme to acquire state information from any of the plurality of devices to be monitored, and monitors the state of the device to be monitored; and a monitor manager which manages monitoring results for the plurality of devices to be monitored, the method including the steps of causing the monitor manager to acquire and manage the state information by the first monitor, and to provide, when the state information has failed to acquire from one of the plurality of devices to be monitored, the second monitor with the instruction to set the one device as a new target for monitoring for acquiring the state information, and to use the state information acquired by the second monitor in response to the instruction to manage the monitoring result.

According to the present invention, it is further provided a monitoring program which causes, when read into, and executed by, a computer, the computer to function as the first monitor, the second monitor and the monitor manager which are described above.

According to the present invention, when monitoring the states of devices to be monitored by means of SNMP, the states of devices to be monitored can be monitored even if a failure occurs in connection with SNMP. Therefore, the present invention improves reliability in comparison with conventional solutions and maintenance people of devices can recognize more accurately the states of the devices.

### BRIEF DESCRIPTION OF THE DRAWINGS

The objects and features of the present invention will become more apparent from consideration of the following detailed description taken in conjunction with the accompanying drawings.

FIG. 1 is a block diagram illustrating a schematic configuration of a device monitoring system according to an embodiment of the present invention;

FIG. 2 shows an example of a monitor table included in a monitoring result memory of FIG. 1; and

FIGS. 3A, 3B and 3C are flowcharts which illustrate an operation procedure of the device monitoring system of FIG. 1.

### BEST MODE FOR IMPLEMENTING THE INVENTION

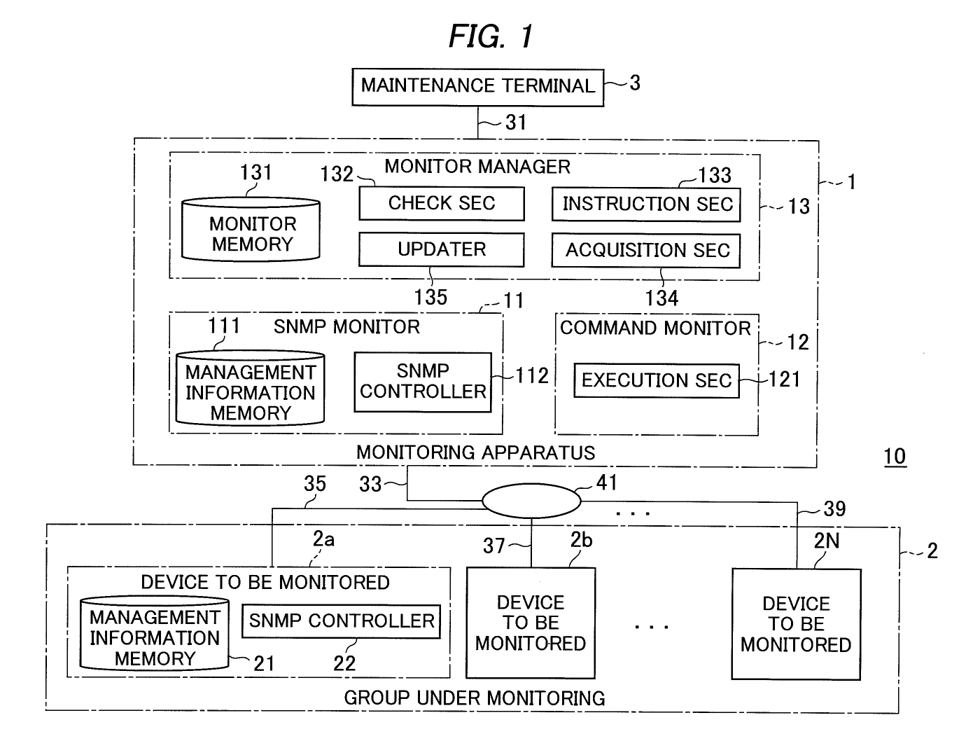

Next, embodiments of a monitoring system according to the present invention will be described in detail with reference to the accompanying drawings. Referring to FIG. 1, a monitoring system 10 of an embodiment is a device monitoring system which monitors a group under monitoring 2 with a monitoring apparatus 1 and displays a monitoring result on a maintenance terminal 3, thus monitoring the states of devices on a telecommunications network. The monitoring apparatus 1 includes an SNMP (Simple Network Management Protocol) monitor 11, which monitors the states of respective devices to be monitored 2a, 2b, . . . , and 2N in the group under monitoring 2, where N represents a natural number. The monitoring apparatus 1 also includes a command monitor 12, which uses a monitor command to acquire state information of a device to be monitored from the group under monitoring 2. The monitor manager 13 checks how the SNMP monitor 11 monitors the respective devices to be monitored 2a, 2b, and 2N, and sets, if there is a device to be monitored from which state information has failed to obtain, that device as a new target for monitoring to cause the command monitor 12 to transmit a monitor command. The command, which will be described in detail later, may be an instruction meant for a network, and hence network equipment, namely, a network command. The command monitor 12 uses the monitor command to acquire the state information from a target device to be monitored, the monitoring result being updated based thereon. The monitoring system 10 of the embodiment thus improves the reliability of a failure monitoring, and maintenance people of devices can recognize more accurately the states of the devices.

Part of the embodiment which is not directly relevant to understanding of the present invention will neither be illustrated nor described. In the following description, signals and data are designated with reference numbers of connections on which signals or data appear.

In the present embodiment, the group under monitoring 2 includes N devices to be monitored 2a, 2b, . . . , and 2N, where N is the natural number, as described above. Thus, a variable number n, where 1≦n≦N, can be used to refer to specific one of the devices to be monitored 2a, 2b, . . . , and 2N.

In the device monitoring system 10 of FIG. 1, the monitoring apparatus 1 and respective devices to be monitored 2a, 2b, . . . , and 2N in the group under monitoring 2 are connected by corresponding signal lines 33, 35, 37, . . . , 39 so as to form a telecommunications network 41, which may be implemented by, for example, IP (Internet Protocol) as a communication protocol.

The maintenance terminal 3 has a function which outputs visibly and/or audibly information on the states of the devices to be monitored 2a, 2b, . . . , and 2N, acquired by the monitoring apparatus 1, i.e. device state information 31, as a monitoring result. The maintenance terminal 3 includes a man-machine interface, such as GUI (Graphical User Interface) control of the monitoring apparatus 1, and can use screen information from the monitoring apparatus 1 to display a page on its display screen and to output audible sound, such as a alerting sound, to an audio output device. The maintenance terminal 3 also includes an operation unit, on which various setting can be made for monitoring the states of the respective devices to be monitored 2a, 2b, . . . , and 2N.

The monitoring apparatus 1 has a function which monitors the device states of the devices to be monitored 2a, 2b, . . . , and 2N. More specifically, the monitoring apparatus 1 has a monitoring function according to SNMP, and a monitoring function by means of a specific command to the devices to be monitored 2a, 2b, . . . , and 2N. The monitoring apparatus 1 provides a monitoring result 31 on the devices to be monitored 2a, 2b, . . . , and 2N to the maintenance terminal 3 by GUI control or the like.

The monitoring apparatus 1 has a function which periodically transmits, according to SNMP, a request signal 33 for requesting for device state information which indicates a device state to the devices to be monitored 2a, 2b, . . . , and 2N, and acquires device state information provided by the devices to be monitored 2a, 2b, . . . , and 2N in response to the signal. The monitoring apparatus 1 further has a function which transmits, when device state information on any of the devices to be monitored 2a, 2b, . . . , and 2N has not been acquired according to SNMP, a specific command, i.e. a monitor execution command, to a device to be monitored 2n from which information has failed to obtain, whereby acquiring device state information from the device to be monitored 2n.

Further, the monitoring apparatus 1 has a function which revises the monitoring result with the device state information on the device to be monitored 2n which is specifically acquired by the command execution. That makes the monitoring apparatus 1, even when having failed to obtain device state information according to SNMP due to a communication failure or the like in SNMP, acquire device state information by the specific command, whereby the monitoring result can be updated.

The monitoring apparatus 1 also has a function which provides various screen information, for example, by GUI control to the maintenance terminal 3. The screen information includes, for example, network traffic information, usage rate of a CPU (Central Processing Unit) or a memory, operational status of hardware and the like on each of the devices to be monitored 2a, 2b, . . . , and 2N. To the maintenance terminal 3, applicable are various display formats for displaying screen information which implement a map display indicative of a network configuration with the devices to be monitored 2a, 2b, . . . and 2N, a graphic display appropriate for the sorts of states of the respective devices, and the like. Alerting sounds appropriate for device state information of the respective devices to be monitored 2a, 2b, . . . , and 2N may be output, or visualization may be implemented with display colors appropriate for device state information.

Describing more specifically, the monitoring apparatus 1 in the present embodiment includes, as monitor means, an SNMP monitor 11, a command monitor 12 and a monitor manager 13 as illustrated in FIG. 1.

In the present embodiment, the monitoring apparatus 1 is implemented by a processing system, i.e. a computer, which includes a CPU, a ROM (Read-Only Memory), a RAM (Random Access Memory), an EEPROM (Electrically Erasable Programmable Read-Only Memory), an input/output interface and the like. The CPU reads and executes processing programs stored in the ROM to implement various functions of the monitoring apparatus 1. FIG. 1 illustrates the functions implemented by the monitoring apparatus 1 in the form of block diagram.

It is noted that processing programs may be in the form of monitoring programs installed in the monitoring apparatus 1. Even in this case, it is needless to say that the processing programs implement the functions of respective functional sections illustrated in FIG. 1, that is, the SNMP controller 11, the command monitor 12 and the monitor manager 13.

The SNMP monitor 11 has a function which monitors the device state of each of the devices to be monitored 2a, 2b, . . . , and 2N according to SNMP. The SNMP monitor 11 functions as a manager of the monitoring system according to SNMP. The manager function is configured to periodically acquire the device state information from the devices to be monitored 2a, 2b, . . . , and 2N. The SNMP monitor 11 may be configured to use SNMP as SNMP Trap to acquire the state information from the devices to be monitored 2a, 2b, . . . , and 2N at a predetermined timing.

Describing the internal configuration in detail, the SNMP monitor 11 includes a management information memory 111 and an SNMP controller 112, as illustrated in FIG. 1. The SNMP controller 112 has a function which controls the state monitoring according to SNMP for the respective devices to be monitored 2a, 2b, . . . , and 2N. A variety of monitoring schemes according to SNMP are applicable to the SNMP controller 112. As for the SNMP controller 112, the information regarding the state monitoring may be defined in the management information memory 111. The SNMP controller 112 acquires device state information from the respective devices to be monitored 2a, 2b, . . . , and 2N in accordance with such definition regarding the state monitoring.

Further describing specifically, the SNMP controller 112 uses the device identifications of the devices to be monitored 2a, 2b, . . . , and 2N and information identifications to periodically request the devices to be monitored 2a, 2b, . . . , and 2N for the device state information of the devices at the predetermined time interval. The SNMP controller 112 can acquire device state information transmitted in response to the request from each of the devices to be monitored 2a, 2b, . . . , and 2N.

Here, device identifications may be information for individually identifying devices, such as the IP addresses of devices whereas information identifications are a collective entity of objects stored in the management information memory 111 in the form of MIB (Management Information Base). More specifically, the information identifications may be the host name of a device entity on a network or information on an element in a device under monitoring. The types of device state information are fixed by object definitions in the management information memory 111, but the present invention is not limited to this manner. The device state information may be defined into various state information.

The various state information may be state information regarding the system of a device to be monitored, state information regarding interface, state information regarding protocols such as IP, state information regarding ICMP (Internet Control Message Protocol), state information regarding TCP (Transmission Control Protocol), state information regarding UDP (User Datagram Protocol) and the like. The type of each device in the group under monitoring 2 includes, for example, identification information on whether it is network equipment or a server, i.e. server/client information. In addition, the SNMP controller 112 may be configured so that the types of device state information to acquire can be set in accordance with an installation manner of devices or the like, and the SNMP controller 112 stores and manages the setting in the management information memory 111.

The SNMP controller 112 compares acquired device state information with one or more thresholds set in accordance with the types of the device state information to obtain logical values indicating a result from the comparison as a monitoring result. The SNMP controller 112 has a function which provides, in response to a request from the monitor manager 13, the monitor manager 132 with the monitoring result of the devices to be monitored 2a, 2b, . . . , and 2N thus requested.

The management information memory 111 has, for example, a function which stores information corresponding to MIB or the like, and the device state information of the devices to be monitored 2a, 2b, . . . , and 2N is managed therein. The management information memory 111 has management information storage areas, each of which holds information associated with one of devices to be monitored 2a, 2b, . . . , and 2N, which are SNMP agents. As the held information, stored are contents corresponding to the held items, specifically, values indicating “completed”/“uncompleted” and “normal”/“failure” and the like. In a system configured so that the monitoring apparatus 1 and each of the devices to be monitored 2a, 2b, . . . , and 2N correspondingly hold information items, the management information memory 111 may be, for example, one which is defined by RFC (Request for Comments) 1155 or unique one extended therefrom.

The monitor manager 13 has a function which manages monitoring results for the devices to be monitored 2a, 2b, . . . , and 2N from the SNMP monitor 11 and the command monitor 12. The monitor manager 13 includes a monitor memory 131 and a check section 132 in terms of monitoring results, an instruction section 133 and an acquisition section 134 in terms of command monitoring, and an updater 135 for monitoring results, as illustrated in FIG. 1.

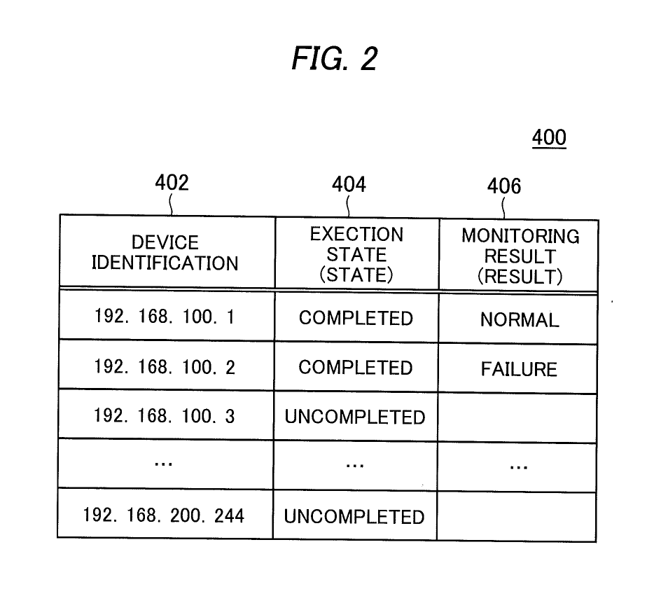

The monitor memory 131 holds a monitor table which manages how the monitoring proceeds 404 (FIG. 2) for the devices to be monitored 2a, 2b, . . . , and 2N, and monitoring results from the devices to be monitored 2a, 2b, . . . , and 2N.

Now with reference to FIG. 2, a configuration example of the monitor table 400 in the present embodiment will be described. In the example illustrated in the figure, the monitor table 400 includes a device identification field 402, an execution state field 404, and a monitoring result field 406, as information items, i.e. input or display fields.

The device identification field 402 may additionally include a name and/or a device type filed or the like to identify, or specify the devices to be monitored 2a, 2b, . . . , and 2N which are monitored by the monitoring apparatus 1.

The execution states (STATE) 404 indicate the progress of the monitoring by the SNMP monitor 11. The monitoring according to SNMP is implemented by, for example, periodically acquiring, through polling or the like, for example, device state information from each of the devices to be monitored 2a, 2b, . . . , and 2N at the predetermined interval. In the execution state field (STATE) 404, the state on whether or not the monitoring of SNMP has been performed on each of the devices to be monitored 2a, 2b, . . . , and 2N is described and updated at the predetermined interval. For example, when the information acquisition has been performed according to SNMP at the predetermined interval, information which means “completed” is stored in the execution state field (STATE) 404 of a corresponding entry, or record, in the form of a logical value corresponding thereto, and when it has not been performed at the predetermined interval, information which means “uncompleted” is stored in the execution state field (STATE) 404 in the form of a logical value corresponding thereto. After one cycle of monitoring is completed on the group under monitoring at a timing, the execution state fields (STATE) 404 of all the entries are reset to an initial state, i.e. “uncompleted”, and the monitoring will be rendered in a standby state until the subsequent monitoring process starts.

The monitoring results (RESULT) 406 indicate monitoring results according to SNMP based on the device state information of each of the devices to be monitored 2a, 2b, . . . , and 2N. The monitoring result fields (RESULT) 406 store, for example, information indicating whether the monitoring result represents normal or failure, the information being obtained by comparing the device state information acquired from the devices to be monitored 2a, 2b, . . . , and 2N with the threshold. When the device state information is equal to or less than the threshold, a logical value indicating “normal” is stored in a corresponding entry, and, when the device state information is greater than the threshold, a logical value indicating “failure” is stored in the corresponding entry. In addition, when information has not been acquired during the monitoring, a logical value corresponding to information indicating “acquisition failure” may be stored.

Note that for the “failure” a single threshold value may not limitatively be set but a plurality of thresholds corresponding to the types or levels of the above may be set. Providing a plurality of thresholds is helpful to recognize the degree of failure on a target for monitoring. As for the “failure”, the degree of the above may be classified, for example, by providing values which indicate “Critical”, “Major”, “Minor” and the like in the descending order of the importance or degree of failure.

Further in the monitoring result fields (RESULT) 406, in addition to storing results from comparison of the device state information with the threshold, “normal” may be stored when a comparison of device state information with a specific value reveals consistency whereas “failure” may be stored when revealing inconsistency.

The checker 132 has a function which references the monitor table 400 to select an entry in which the execution state field (STATE) 404 indicates “uncompleted”, and acquires from the SNMP monitor 11 the monitoring result of one of the devices to be monitored 2a, 2b, . . . , and 2N which corresponds to the selection. More specifically, when the checker 132 selects an entry in which the execution state (STATE) 404 is “uncompleted”, it notifies the SNMP monitor 11 of the device identification 402 in that selected entry. The SNMP monitor 11 acquires the monitoring result of the device to be monitored 2a, 2b, . . . , or 2N corresponding to the device identification 402, and transfers the result to the checker 132. The checker 132 transfers the acquired monitoring result to the updater 135.

The instruction section 133 has a function which acquires the monitoring result of an appropriate device 2n among the devices to be monitored 2a, 2b, . . . , and 2N from the SNMP monitor 11, and instructs, when the monitoring result acquired according to SNMP indicates “acquisition failure”, the command monitor 12 to monitor the state of device by command execution.

A case in which the monitoring result according to SNMP indicates “acquisition failure” is the case in which the SNMP monitor 11 has requested a device to be monitored 2n for providing device state information according to SNMP, but has failed in getting device state information. In this case, occurrence of a failure in connection with SNMP can be estimated, such as communication failure of SNMP with the device 2n in the group under monitoring 2, or failure of the SNMP agent in the group under monitoring 2. When such a failure in connection with SNMP occurs, the instruction section 133 notifies, in order to cause the command monitor 12 to perform state monitoring of the device to be monitored 2n by the specific command, the command monitor 12 of the device identification of the appropriate device to be monitored 2n in the group under monitoring 2, and instructs execution of the command.

The acquisition section 134 has a function which receives the monitoring result of a device to be monitored 2n by the command execution from the command monitor 12 when the instruction section 133 instructs the monitoring by execution of a command.

The updater 135 has a function which uses the monitoring result of a device to be monitored 2n obtained from the SNMP monitor 11 or the command monitor 12 to update the content of a corresponding entry in the monitor table 400. More specifically, the updater 135 updates, when obtaining the monitoring result of “normal”/“failure” from the SNMP monitor 11, the content of a corresponding entry by that monitor result. The updater 135 revises, when receiving the monitoring result of “acquisition failure” from the SNMP monitor 11, a corresponding entry in the monitor table 400 by the monitoring result obtained from the command monitor 12.

The command monitor 12 has a function which performs state monitoring of a device to be monitored 2n by a predetermined command when receiving an instruction from the monitor manager 13. The command monitor 12 includes an execution section 121, as illustrated in FIG. 1. The execution section 121 has a monitoring execution function which uses the instruction from the monitor manager 13 to transmit the predetermined command to the designated device to be monitored 2n, so that the device to be monitored 2n is caused to return the state information.

As the monitoring scheme by commands, various schemes can be widely applied to the group under monitoring 2 as long as the schemes can reference the state of the devices. The command monitor 12 may be configured such as not only to acquire a single type of state information but also to acquire plural types of state information. In the latter case, a procedure for obtaining plural types of state information may be set in advance in the monitoring apparatus 1 or the command monitor 12, and the command monitor 12 maybe adapted to use a plurality of commands corresponding to the types to obtain respective state information items.

Specifically, in order to reference various types of state information, the command monitor 12 may be adapted to use the device identifications such as IP addresses of the devices to be monitored 2a, 2b, . . . , and 2N by means of communications protocol such as telnet to transmit a Ping command to a device to be monitored 2n to thereby acquire the state information on monitoring the traffic of a network, and to transmit to a device to be monitored 2n commands prompting output of the presence or absence of various hardware failures, the number of times of transmission/reception packets, the usage rate of a CPU or memory or the like to thereby acquire state information. The device identifications may be a host name, a port number and the like, as required.

The command monitor 12 may also be adapted to arrange a specific command in advance for a device to be monitored 2n to use the arranged specific command to acquire various types of device state information. The execution section 121 uses device state information acquired from the group under monitoring 2 and one or more of thresholds to determine which of “normal”, “failure” and “acquisition failure” the monitoring result represents, providing the monitoring result to the monitor manager 13.

Note that the command handled by the execution section 121 may be different from the SNMP command in command format and also in state information format. The execution section 121 may however be configured so as to be adjusted in the difference between such formats to provide the monitoring result.

In addition, the monitoring apparatus 1 in FIG. 1 is not limited to the configuration mentioned above, but may be implemented by programs for achieving the functions of the SNMP monitor 11, command monitor 12 and monitor manager 13, the programs being stored in, and read out from, a computer readable recording medium as appropriate. The recording medium may be, for example, a CD-ROM (Compact Disc Read-Only Memory), a USB (Universal Serial Bus) memory, an EEPROM (Electrically Erasable Programmable Read-Only Memory) semiconductor memory and the like.

The group under monitoring 2 includes the devices to be monitored 2a, 2b, . . . , and 2N, the states of which are monitored by the monitoring apparatus 1. Those devices to be monitored include, for example, network equipment such as switch device and gateway device, and various communication network elements such as server. Each of the devices to be monitored 2a, 2b, . . . , and 2N includes a management information memory 21 and an SNMP controller 22, as illustrated in FIG. 1.

The management information memory 21 has a function which stores information corresponding to MIB or the like, and manages the state information of a device to be monitored in which the management information memory 21 is provided. The management information memory 21 may be adapted to manage information defined by RFC 1155, for example, or manage extended specific information.

The SNMP controller 22 has a function of transmitting to SNMP monitor 11 device state information requested from the SNMP monitor 11 according to SNMP, and functions as an agent of the monitoring system according to SNMP.

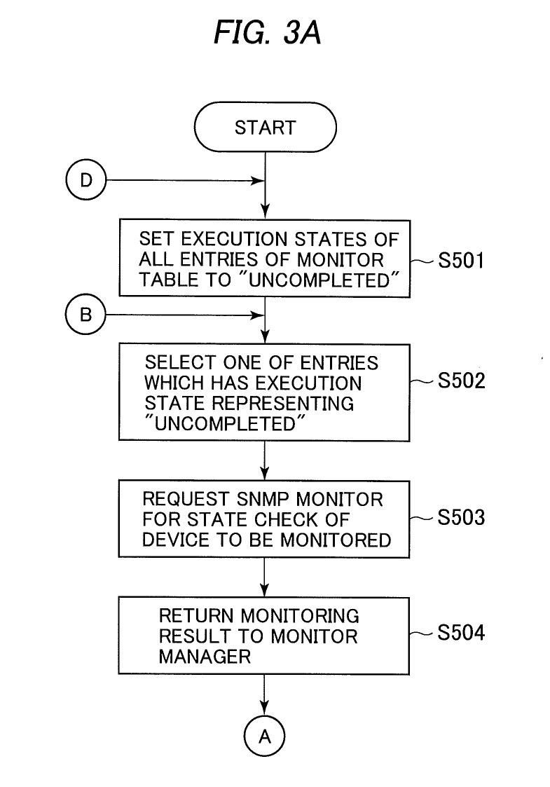

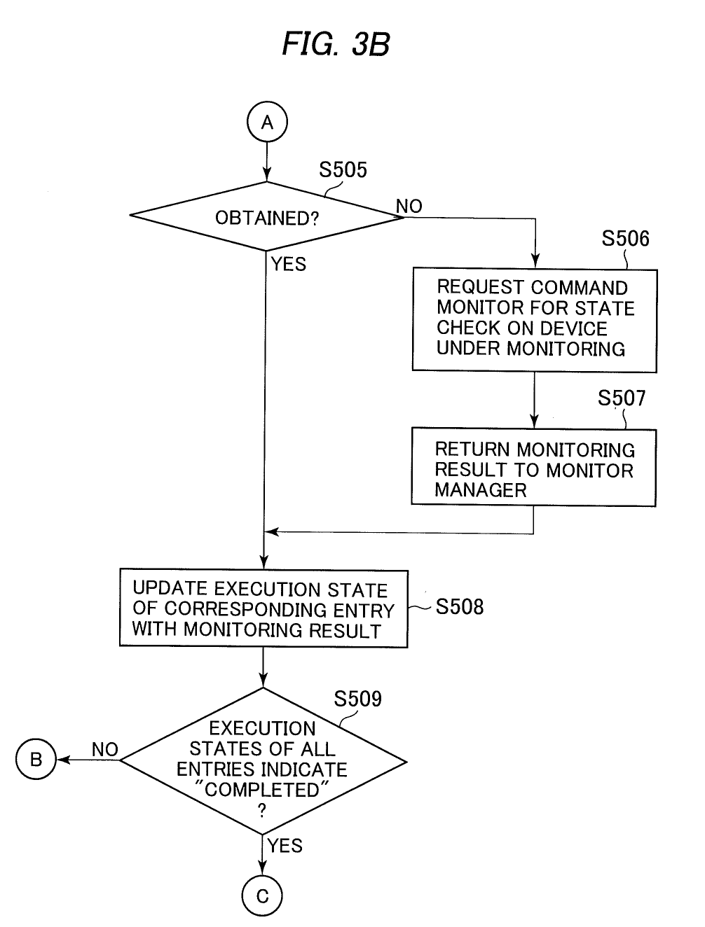

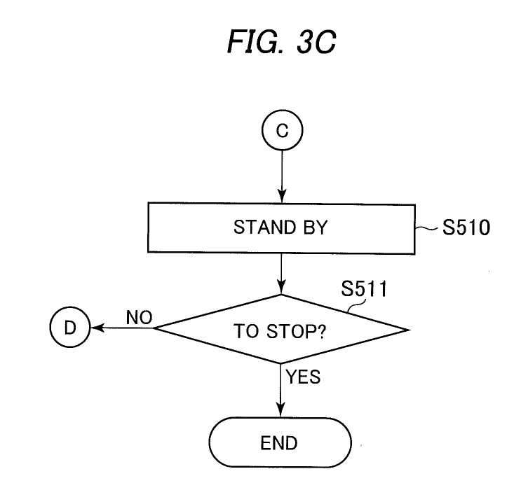

Next, referring to FIGS. 3A, 3B and 3C, the operation of device monitoring of the monitoring apparatus 1 of the device monitoring system 10 according to the present embodiment will be described. Those three figures form, in combination, a flowchart which illustrates an operational procedure of the device monitoring process.

First, referring to FIG. 3A, after the monitoring apparatus 1 is started up, the monitor manager 13 sets the execution state fields (STATE) 404 of all the entries of the monitor table 400 to “uncompleted” (step S501).

The monitor manager 13 references the monitor table 400 and selects an entry for any device 2n among the devices to be monitored which has its execution states (STATE) 404 representing “uncompleted” (step S502). The order to selecting the targets for monitoring, i.e. the devices to be monitored, is not limited. For example, random selection, the order of registering entries in the monitor table 400, or the order according to a predetermined priority may be applied.

After such entry selection, the monitor manager 13 transfers the device identification in the entry to the SNMP monitor 11, and requests the SNMP monitor 11 for checking the state of the device to be monitored 2n associated with the device identification (step S503).

When the SNMP monitor 11 receives a state check request for the device to be monitored 2n from the monitor manager 13, it accesses the management information memory 111, and produces a GET command of SNMP with the device identification, thus notified from the monitor manager 13, set as a destination thereof to transmit the command in the form of GET message. In the present embodiment, an object designated by the GET command is device state information, and the type of device state information is set in advance. The SNMP monitor 11 transmits to an agent the GET message (GetRequest) which includes an object identification (Object IDentification) as an information identification to acquire.

The SNMP monitor 11 determines the state of the target for monitoring, and transfers a result from the determination to the monitor manager 13 (step S504). The determination result is transferred to the SNMP monitor 11 as a GetResponse message of SNMP from the device to be monitored 2n which is an agent. The SNMP monitor 11, which has received the determination result as a response, acquires the device state information included in the GetResponse message.

Describing specifically, the SNMP monitor 11 determines “normal”/“failure” in respect of the state of the target for monitoring, and notifies the monitor manager 13 of the determination result as a monitoring result. In the determination, the device state of the device to be monitored 2n as a target for monitoring is determined on the basis of the acquired device state information and one or more of thresholds which are previously set. Now, when the result from the monitoring according to SNMP to the target for monitoring mentioned above reveals a failure of obtaining device state information, the SNMP monitor 11 notifies the monitor manager 13 of the monitoring result which indicates “acquisition failure”. For example, the SNMP monitor 11 may be adapted to determine “acquisition failure” when a predetermined period of time has elapsed without receiving a GetResponse message since the SNMP monitor 11 transmitted the GET message. Alternatively, the SNMP monitor 11 may be adapted to have the number of retries of transmitting a GET message set in advance, and to determine “acquisition failure” when the number of retires of transmitting GET messages exceeds the set number of retries.

After the notification of the monitoring result, the monitoring apparatus 1 proceeds to the determination step S505 in FIG. 3B through a connection terminal A in FIG. 3A.

The monitor manager 13 uses the monitoring result from the SNMP monitor 11 to determine whether or not the monitoring result indicating the state of the device to be monitored 2n that is a target for monitoring has been obtained (step S505). When the monitoring result of “normal”/“failure” is obtained (YES), the monitor manager 13 determines that the monitoring result indicating the device state of the device to be monitored 2n under monitoring has been obtained. In this case, the monitor manager 13 sets the execution state (STATE) 404 of the correspondence entry in the monitor table 400 to “completed”, and proceeds to the updating step S508 of setting the monitoring result (RESULT) 406 to either “normal” or “failure”.

By contrast, if the monitoring result of “acquisition failure” is obtained (NO) in the determination step S505, then the monitor manager 13 determines that any failure occurs in SNMP and that the information regarding the state has not been acquired from the device to be monitored 2n under monitoring. The monitor manager 13 then notifies the command monitor 12 of the device identification of the device to be monitored 2n to thereby proceed to the processing step S506 which requests a state check by command to be made on the device to be monitored 2n from which a device identification is failed to obtain.

The request processing step S506 of a state check causes the monitor manager 13 to send out a state check request for a device to be monitored 2n on which information has not been acquired to the command monitor 12.

When the state check is requested, the command monitor 12 performs state monitoring by a predetermined command on the device to be monitored 2n to acquire device state information, and transfers a monitoring result to the monitor manager 13 as a command response (step S507). According to the command response, the command monitor 12 compares the device state information acquired from the device to be monitored 2n, from which information was not available, with one or more thresholds, and obtains a monitoring result from the comparison result. In this way, the command monitor 12 obtains the monitoring result of “normal”/“failure” or “acquisition failure”. The command monitor 12 transfers the monitoring result to the monitor manager 13, and proceeds to the update step S508 which sets the monitoring result (RESULT) 406 to a corresponding value.

The command monitor 12 determines an “acquisition failure” when a predetermined period of time has elapsed without receiving a reply since the command transmission, and also determines an “acquisition failure” when the number of times of command transmission exceeds the predetermined number of retries.

Next, the monitor manager 13 uses the monitoring result from the command monitor 12 to update the value of the corresponding entry in the monitor table 400 (step S508). Specifically, when the monitoring result which indicates “normal”/“failure” is provided, the monitor manager 13 sets the execution state (STATE) 404 of the corresponding entry in the monitor table 400 to the value corresponding to “completed”, and sets the monitoring result (RESULT) 406 to the value corresponding to “normal”/“failure”. Moreover, when the monitoring result which indicates “acquisition failure” is provided, the monitor manager 13 sets the execution state (STATE) 404 of the corresponding entry in the monitor table 400 to the value corresponding to “completed”, and sets the monitoring result (RESULT) 406 to the value corresponding to “acquisition failure”.

Note that the monitor manager 13 may be adapted to notify the maintenance terminal 3 of the fact that monitoring is made by command execution when the command monitor 12 performs the monitoring by command execution. In this case, IP address specifying a device to be monitored 2n under monitoring and information specific to the device such as a host name may be also notified to the maintenance terminal 3. In other words, the notification of such information items means reporting the occurrence of a failure in connection with SNMP to a service person. The monitor manager 13 may be adapted to reference the monitor table 400 to notify, when the monitoring result (RESULT) 406 indicates “acquisition failure”, the maintenance terminal 3 of the “acquisition failure” to.

Next, the monitor manager 13 references the monitor table 400 to determine whether or not the execution states (STATE) 404 of all the entries indicate “completed” (step S509). When an entry with “uncompleted” is found (NO), in order to continue the monitoring operation, the procedure proceeds to the selection step S502 in FIG. 3A through a connection terminal B in FIG. 3B. By contrast, when the execution states (STATE) 404 of all the entries indicate “completed” (YES), the monitor manager 13 proceeds to the standby step S510 in FIG. 3C through a connection terminal C in FIG. 3B. In the standby step, the processing stands by until a subsequent time for executing monitoring.

When the subsequent time for executing monitoring comes in the standby step S510, it is determined whether or not the monitor manager 13 is to be disabled (step S511). For example, when disabling the monitor manager 13 by a manipulation from the outside or the like (YES), the monitor manager 13 proceeds to the terminating step to terminate the series of processes. By contrast, when the monitor manager 13 continues the monitoring (NO), the monitor manager 13 renders the procedure to proceed to the setting step S501 in FIG. 3A through a connection terminal D in FIG. 3C.

In summary, according to present embodiment, when the state information of a device to be monitored becomes hard to acquire according to SNMP due to a communication failure in SNMP protocol or a failure of an SNMP agent of a device to be monitored on a network, the device monitoring system 10 acquires the state information of the device to be monitored 2n by acquiring the device state information by command. In this way, acquisition processing is performed to all the devices to be monitored 2a, 2b, . . . , and 2N to recognize the states thereof. This results in an improvement of reliability in failure monitoring of devices by the monitoring apparatus 1 in comparison with the conventional solutions, and allows maintenance people of the devices to recognize more accurately the states of the devices.

Although various modified embodiments of the present invention have been mentioned in the above description of the embodiments, the present invention may be implemented by alternative embodiments as follows.

In the embodiments described above, the monitoring apparatus 1 is configured to monitor the device state by utilizing the monitoring according to SNMP and the monitoring by command. The monitoring scheme performed when a failure occurs in connection with SNMP is not limited to the monitoring scheme by command execution as described above, but a monitoring scheme may be applied in which messages uniquely defined between the monitoring apparatus 1 and each of devices 2a, 2b, . . . , and 2N in the group under monitoring 2 are transmitted and received. Alternatively, two schemes may be included which are comprised of the monitoring scheme by command execution and the monitoring scheme by unique-message transmission and reception.

In addition, the embodiment described above has the single command monitor 12, but a plurality of command monitors 12 may be provided. Specifically, a plurality of command monitors may be configured to reference the respectively different device states, and the monitoring apparatus 1 may reflect the device state information acquired by the respective monitors onto the monitoring results. Providing a plurality of command monitors and increasing the combinations of available device state information in this way cause the monitoring apparatus 1 to further improve the reliability of state monitoring for the devices to be monitored 2a, 2b, . . . , and 2N.

Further, if a plurality of command monitors are provided, the command monitors may be arranged selectable which perform the monitoring appropriate for the types of the devices to be monitored 2a, 2b, . . . , and 2N. As a specific example, when a device to be monitored is network equipment such as a switch device, the monitor manager 13 in the monitoring apparatus 1 allows the command monitor 12 to monitor network communication state of the network equipment, such as network traffic conditions, the number of transmission and reception packets and the number of transmission and reception packet losses, to thereby conduct the state monitoring. When a device to be monitored is a server, the monitor manager 13 maybe configured to allow the command monitor 12 to monitor the state inside the device, such as the usage rate of its CPU and memory, and the operational status of hardware, in addition to the network traffic conditions of network, the number of transmission and reception packets, the number of transmission and reception packet losses and the like, to thereby conduct the state monitoring.

The procedures of the device monitoring by the monitoring apparatus 1 are not limited to the specific procedure illustrated in FIGS. 3A, 3B and 3C. According to the procedure illustrated in the figures, when the monitoring according to SNMP has failed to get information from one selected device to be monitored 2n, the monitoring by command execution is performed subsequent thereto. However, such a procedure is not limitative, but the monitoring according to SNMP may be tried to all the devices to be monitored 2a, 2b, . . . , and 2N, and thereafter the monitoring by command execution may be performed on the device to be monitored 2n which has the monitoring result indicative of acquisition failure.

The entire disclosure of Japanese patent application No. 2013-005657 filed on Jan. 16, 2013, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

1. A monitoring system comprising:
a first monitor which acquires state information from each of a plurality of devices to be monitored based on a first monitoring scheme, and monitors states of the plurality of devices to be monitored;
a second monitor which is responsive to an instruction based on a second monitoring scheme to acquire state information from any of the plurality of devices to be monitored, and monitors a state of the device to be monitored; and
a monitor manager which manages monitoring results for the plurality of devices to be monitored,
wherein said monitor manager acquires the state information by said first monitor to manage the state information, and, when the state information has failed to acquire from one of the plurality of devices to be monitored, said manager provides said second monitor with the instruction to set the one device as a new target for monitoring for acquiring the state information, and uses the state information acquired by said second monitor in response to the instruction to manage the monitoring result.

2. The monitoring system in accordance with claim 1, wherein
said monitor manager includes a monitor memory which stores execution states of a monitoring by said first monitor and the monitoring results for the plurality of devices to be monitored respectively in association with the plurality of devices to be monitored, and
said monitor manager sets the device to be monitored, from which the state information has failed to acquire in the monitoring by said first monitor, as the new target for monitoring, and provides the instruction to said second monitor.

3. The monitoring system in accordance with claim 2, wherein said monitor manager includes:
a checker which references said monitor memory to set a device of which the execution state indicates uncompleted among the plurality of devices to be monitored as the target for monitoring, and provides the instruction to said first monitor;
an instruction section which sets the device to be monitored, from which the state information has failed to acquire, as the new target for monitoring, and provides the instruction to said second monitor;
an acquisition section which acquires as the monitoring result the state information which said second monitor acquires from the device to be monitored in response to the instruction; and
an updater which uses the state information acquired by either said first monitor or said second monitor to update the monitoring result in said monitor memory.

4. The monitoring system in accordance with claim 1, wherein the first monitoring scheme is SNMP (Simple Network Management Protocol), and said first monitor includes:
an object manager which manages the device state information acquired according to definition regarding state monitoring for the plurality of devices to be monitored; and
a controller which determines the monitoring result from comparing the device state information acquired with a threshold set in accordance with a type of the device state information.

5. The monitoring system in accordance with claim 1, wherein the second monitoring scheme is a command method which references the state of each of the plurality of devices to be monitored.

6. The monitoring system in accordance with claim 1, further comprising a plurality of second monitors, wherein the second monitoring scheme is a command method which references the state of each of the plurality of devices to be monitored, and plural types of state information are acquired.

7. A monitoring apparatus comprising:
a first monitor which acquires state information from each of a plurality of devices to be monitored based on a first monitoring scheme, and monitors states of the plurality of devices to be monitored;
a second monitor which is responsive to an instruction based on a second monitoring scheme to acquire state information from any of the plurality of devices to be monitored, and monitors a state of the device to be monitored; and
a monitor manager which manages monitoring results for the plurality of devices to be monitored,
wherein said monitor manager acquires the state information by said first monitor to manage the state information, and, when the state information has failed to acquire from one of the plurality of devices to be monitored, said manager provides said second monitor with the instruction to set the one device as a new target for monitoring for acquiring the state information, and uses the state information acquired by said second monitor in response to the instruction to manage the monitoring result.

8. The monitoring apparatus in accordance with claim 7, wherein
said monitor manager includes a monitor memory which stores execution states of a monitoring by said first monitor and the monitoring results for the plurality of devices to be monitored in association with the plurality of devices to be monitored, and
said monitor manager sets the device to be monitored, from which the state information has failed to acquire in the monitoring by said first monitor, as the new target for monitoring, and provides the instruction to said second monitor.

9. The monitoring apparatus in accordance with claim 8, wherein said monitor manager includes:
a checker which references said monitor memory to set a device of which the execution state indicates uncompleted among the plurality of devices to be monitored as the target for monitoring, and provides the instruction to said first monitor;
an instruction section which sets the device to be monitored, from which the state information has failed to acquire, as the new target for monitoring, and provides the instruction to said second monitor;
an acquisition section which acquires as the monitoring result the state information which said second monitor acquires from the device to be monitored in response to the instruction; and
an updater which uses the state information acquired by either said first monitor or said second monitor to update the monitoring result in said monitor memory.

10. The monitoring apparatus in accordance with claim 7, wherein the first monitoring scheme is SNMP (Simple Network Management Protocol), and said first monitor includes:
an object manager which manages the device state information acquired according to definition regarding state monitoring for the plurality of devices to be monitored; and
a controller which determines the monitoring result from comparing the device state information acquired with a threshold set in accordance with the type of the device state information.

11. The monitoring apparatus in accordance with claim 7, wherein the second monitor scheme is a command method which references the state of each of the plurality of devices to be monitored.

12. The monitoring apparatus in accordance with claim 7, further comprising a plurality of second monitors, wherein the second monitoring scheme is a command method which references the state of each of the plurality of devices to be monitored, and plural types of state information are acquired.

13. A monitoring method for monitoring based on state information from each of a plurality of device to be monitored, wherein a monitoring apparatus is used which comprises:
a first monitor which acquires state information from each of the plurality of devices to be monitored based on a first monitoring scheme, and monitors states of the plurality of devices to be monitored;
a second monitor which is responsive to an instruction based on a second monitoring scheme to acquire state information from any of the plurality of devices to be monitored in, and monitors a state of the device to be monitored; and
a monitor manager which manages monitoring results for the plurality of devices to be monitored,
said method comprising the steps of causing the monitor manager to acquire and manage the state information by the first monitor, and to provide, when the state information has failed to acquire from one of the plurality of devices to be monitored, the second monitor with the instruction to set the one device as a new target for monitoring for acquiring the state information, and to use the state information acquired by the second monitor in response to the instruction to manage the monitoring result.

14. A monitoring program, when read into and executed by a computer, causing the computer to function as:
a first monitor which acquires state information from each of a plurality of devices to be monitored based on a first monitoring scheme, and monitors states of the plurality of devices to be monitored;
a second monitor which is responsive to an instruction based on a second monitoring scheme to acquire state information from any of the plurality of devices to be monitored, and monitors a state of the device to be monitored; and
a monitor manager which manages monitoring results for the plurality of devices to be monitored,
the monitor manager acquiring the state information by the first monitor to manage the state information, and providing, when the state information has failed to acquire from one of the plurality of devices to be monitored, the second monitor with the instruction to set the one device as a new target for monitoring for acquiring the state information to use the state information acquired by the second monitor in response to the instruction to manage the monitoring result.
